(19) United States
(12) Patent Application Publication
(10) Pub. No.: US 2005/0115556 A1
(43) Pub. Date: Jun. 2, 2005

(54) Turkey fryer/outdoor cooker wind and fire guard

(76) Inventors: Kenneth Carson, Madison, AL (US); Helen Carson, Madison, AL (US)

Correspondence Address: Donald W. Meeker, 924 East Ocean Front #E, Newport Beach, CA, 92661, US

(21) Appl. No.: 10/726,282

(22) Filed: Dec. 1, 2003

(51) Int. Cl. A47J 37/00

(52) U.S. Cl. 126/25 R

(57) ABSTRACT

A wind screen device for an outdoor grill is provided, which comprises a horizontal bottom plate and a series of vertical side plates. The vertical side plates contact each other and the bottom plate to form an enclosure or windscreen. The enclosure is capable of housing a variety of types and sizes of outdoor cooking units, thereby screening out the wind from the outdoor cooking unit. The rigid plates are hooked together by split rings, which are threaded through slotted holes located near the edges of the plates. The side plates are held in place by angled clips when the windscreen device is assembled. The side plates are also capable of being alternately folded down with all of the plates stacked together for storage. The windscreen device includes an additional opening in one of its side plates, which is designed to admit a gas hose therethrough.

### BACKGROUND OF THE INVENTION

1. Field of the Invention

This invention relates to the field of outdoor grills or barbeques, and in particular a wind and fire guard that is used in conjunction with the turkey fryer/outdoor cooker.

2. Description of the Prior Art

Gas fired barbecues have become very popular. A gas barbecue generally comprises a housing or cabinet that supports a grill over a combustion chamber. A burner in the combustion chamber attaches to a gas bottle as a fuel source. The popularity of these gas-fired barbecues as an alternative to charcoal barbecues stems from ease of use, the elimination of ash disposal and minimal cleaning requirements after each use.

A number of particularly desirable features for charcoal and gas fired barbecues have evolved over the last several years. In both charcoal and gas fired barbecues it also important that the combustion chamber operate reliably in a variety of wind conditions.

One of the main problems encountered when using gas barbecues is a result of grease drippings that fall from meat cooked on the grill down into the barbecue housing. If the drippings come into contact with either the burners or the open flame they can become ignited presenting a dangerous situation.

U.S. Pat. No. 1,238,142, issued Aug. 28, 1917 to Hitchcock, provides a simple and efficient collapsible camper's stove. The device is constructed to be as light as possible and can be folded into a comparatively flat form, thereby rendering it compact for ease of carrying. The device embodies four side members that are preferably constructed of thin sheet metal and are hingedly connected.

U.S. Pat. No. 2,469,885, issued May 10, 1949 to Molla, shows a collapsible fire-box unit that may be packed in a substantially flat comparatively thin package during shipment and when not in use. The fire-box adapts to barbecue devices of knockdown or collapsible construction so that the entire device may be packed or stored away.

U.S. Pat. 2,556,365, issued Jun. 6, 1951 to McKnight, Jr., claims a combination portable outdoor cooking stove and barbecue of extremely simple construction. The device is capable of being readily closed up into a compact unit for storage and transportation. The device may also be readily opened for use to provide a compact cooking stove and barbecue adapted to be employed out of doors.

U.S. Pat. No. 3,384,066, issued May 21, 1968 to Tufts, describes a foldable sheet metal charcoal burner that has four trapezoidal side walls which are hinged to form a truncated pyramid. A grate is pivoted horizontally against one wall substantially above the base of the pyramid and releasably attached to the opposite wall, whereby the grate may be released to fall and dump the fire. One hinge pin is removable to fold the device or arrange it with the two sides adjacent to the hinge pin parallel with a grill extending between such two sides, whereby the sides form a fire shield and grill support which has an open side.

U.S. Pat. No. 3,494,349, issued Feb. 10, 1970 to Allen, discloses a windshield particularly adapted to be mounted on a grill bowl. The windshield comprises, in preferred form, at least two panels associated together for providing the windshield configuration, at least one of the panels being movable between (a) the windshield configuration where all panels are substantially flush with the grill bowl's rim and (b) a chimney configuration where the chimney sides define an area on the grill bowl's bottom substantially less than the total area of the bottom.

U.S. Pat. No. 4,256,080, issued Mar. 17, 1981 to Seach, puts forth a grill such as a Hibachi or barbecue grill that has a cover or lid hinged thereto. The grill also has means for selectively closing the lid over the grill at a desired angle with respect thereto, to protect against wind and regulate the cooking rate.

U.S. Pat. No. 5,333,540, issued Aug. 2, 1994 to Mazzocchi, concerns a free standing collapsible, portable barbeque adapted to be moved between a closed/folded configuration and an open/assembled configuration and from an open/assembled configuration to a closed/folded configuration thereby assuming the character of a portable suitcase. The barbeque comprises a substantially cubic receptacle supported by legs pivotally attached to the underside of the receptacle so that they fold inwardly to a plane parallel with the base of the receptacle. A lid is pivotally connected to the receptacle which when open acts as a rear baffle and when closed as a cover for the receptacle. The barbeque has first and second side baffles which are adapted to move independently of the lid each pivotally connected to the base of the receptacle and between a sidewall of the receptacle; and a well formed within said receptacle which acts as a cooking waste trap. Supporting means on the first and second side baffles to enable adjustable support of one or more cooking trays and/or a rotisserie. There are ports to enable the injection of gas to a gas operated heat source or an area to receive dry combustibles as a heat source within the receptacle. There are fastener means on the lid or receptacle to enable the lid to be fastened to the receptacle when the barbeque is in the folded configuration.

U.S. Pat. No. 5,495,845, issued Mar. 5, 1996 to Hait, illustrates a compact outdoor cooking unit that has a cooking mode and a transport and storage mode. The outdoor cooking unit has a foldable stove. In the cooking mode, the stove is in the extended state. A base plate of a firebox has a hook flange and the foldable stove has a releasable locking flange along the lower end of an end wall thereof. The locking flange of the stove is releasably secured to the hook flange of the base plate when the foldable stove is in an extended state for the cooking mode. The outdoor cooking unit also includes a base, a pan, and a griddle. In the transport and storage mode, the pan is seated on the base within the upstanding walls of the base. In the transport and storage state, a griddle seats on the pan with the depending walls of the griddle surrounding the pan. The base, the pan, and the griddle, respectively, have vertically aligned handle hooks. In the transport and storage state, a strap surrounds the base, the pan, and the griddle and passes through the vertically aligned handle hooks of the base, pan, and griddle for maintaining the outdoor cooking unit in a compact mode.

U.S. Pat. No. 4,829,975, issued May 16, 1989 to Hait, is for a fire grate that is formed with a slot configured to receive a narrow dimensioned section of a briquette. The walls surrounding the slot support the briquette in vertical orientation with the narrow dimensioned section of the briquette extending upwardly. Combustion air or gas flows through the slot for exposing the briquette to the combustion air or gas.

U.S. Pat. No. 4,531,505, issued Jul. 30, 1985 to Hait, provides a cooking unit includes an oven with a drawer. For storage and for transporting a folded truncated pyramidal firebox, a folded truncated pyramidal support member, a diffuser, a grill, a griddle, a windbreak and cover are disposed over the oven. The cover is releasably secured to the top of the oven and the folded truncated pyramidal firebox, the folded truncated pyramidal support member, the diffuser, the grill, the griddle and the windbreak are retained therebetween in a compact form. In use, the oven with the drawer may be employed as the base of the cooking unit or, in the alternative, the oven may be disposed above the extended truncated pyramidal firebox, the extended truncated pyramidal support member and the diffuser. In the alternate arrangement, the cover serves as the base for the cooking unit.

U.S. Pat. No. 5,979,428, issued Nov. 9, 1999 to Greene, Jr., shows a retrofitable wind screen for portable gas cookers. The device, made of sheet metal, readily adjusts to fit almost any portable gas cooker and fits around the outside of the cooker frame extending a minimum of three inches above the cooker grate. The device shields the gas flame from the effects of wind and increases the overall cooking efficiency of a gas cooker. Finally, because the device extends above the cooking surface, it provides a measure of safety by preventing the accidental movement of a cooking utensil from the cooking surface.

U.S. Pat. No. 5,682,872, issued Nov. 4, 1997 to Whitted, describes a camping furnace used for cooking or warming food outdoors. The apparatus surrounds the burning fuel and directs smoke upward. Fuel and heat are used efficiently and the danger of the spread of fire is minimized. When it is safe to do so, the apparatus may be easily moved, leaving ash and spent fuel behind. Preferably, the enclosure wall of the furnace is made of separable and/or hinged sections, for adapting the furnace to a flatter, more compact shape for storage and transport.

What is needed is an inexpensive yet effective windscreen that can be easily assembled and easily dismantled, cleaned and stored that can be used with a variety of types and sizes of outdoor grills.

### SUMMARY OF THE INVENTION

An object of the present invention is to provide an inexpensive yet effective wind screen that can be easily assembled and easily dismantled, cleaned and stored that can be used with a variety of types and sizes of outdoor grills.

Another object of the present invention is to provide a windscreen for an outdoor grill that provides access for a gas hose hookup.

One more object of the present invention is to provide a windscreen device for an outdoor grill that helps to contain oil splashes, thereby preventing accidents caused by slick walkways.

An additional object of the present invention is to provide an added safety feature of helping to contain any possible fire that should occur while using an outdoor cooker.

A further object of the present invention is to fabricate the wind screen out of fire resistant materials such as sheet metal or a collapsible foil covered card board.

In brief, a wind screen device for an outdoor grill is provided, which comprises a horizontal bottom plate and a series of vertical side plates. The vertical side plates contact each other and the bottom plate to form an enclosure. The rigid plates are capable of being alternately interconnected to form a windscreen, which is capable of housing an outdoor cooking means, thereby screening out the wind from the outdoor cooking means. Each of the side plates has a pair of slotted openings therethrough that are adjacent to a bottom edge of the side plate. The bottom plate has four slotted pairs of mating openings therethrough, one pair located parallel and adjacent to each of the four edges of the bottom plate. A series of rings form the bottom connecting means and are each insertable through adjacent mating openings between the bottom plate and a side plate. Each of rings comprise a split metal ring that is capable of being opening and inserted through the plate openings and also capable of closing to secure the plates together.

During assembly, angled clips are installed on an adjacent pair of side plates to maintain the side plates upright in contacting alignment with each other and with the bottom plate. The right-angled clips may be removed from the side plates to allow the side plates to fold down upon the bottom plate for storage. The angled clips are fabricated from a heat resistant material, and may be molded of a heat resistant synthetic material or formed from cut and bent sheet metal.

The windscreen device includes an additional opening in one of its side plates, which is designed to admit a gas hose therethrough.

An advantage of the present invention is that it provides a windscreen for an outdoor grill.

Another advantage of the present invention is that may be easily collapsed for shipping or storage purposes.

An additional advantage of the present invention is that it provides access for gas hookup.

One more advantage of the present invention is that it is inexpensive to manufacture.

Yet another advantage of the present invention is that it is easy to assemble.

Still another advantage of the present invention is that it helps keep the outdoor cooking area cleaner.

A further advantage of the present invention is that it provides help in fire containment, should a fire occur on the grill.

Another advantage of the present invention is that it keeps oil from splashing on walkways.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the outdoor grill windscreen device fully assembled;

FIG. 2 is a perspective view of the outdoor grill windscreen with the sides collapsed down onto the bottom for storage;

FIG. 3 is a top plan view of the outdoor grill windscreen device with the sides collapsed out away from the bottom;

FIG. 4 is a perspective view of an alternate embodiment of the outdoor grill windscreen device having a covering over the four vertical sides and two opposite bendable sides capable of bending along a vertical centerline;

FIG. 4A is a cutaway perspective view of the front corner of the device of FIG. 4 showing the covering over the plates;

FIG. 5 is a perspective view of the alternate embodiment of FIG. 4 having a covering over the four vertical sides and showing the two opposite bendable sides bending inwardly to collapse the grill windscreen device for flat storage.

### BEST MODE FOR CARRYING OUT THE INVENTION

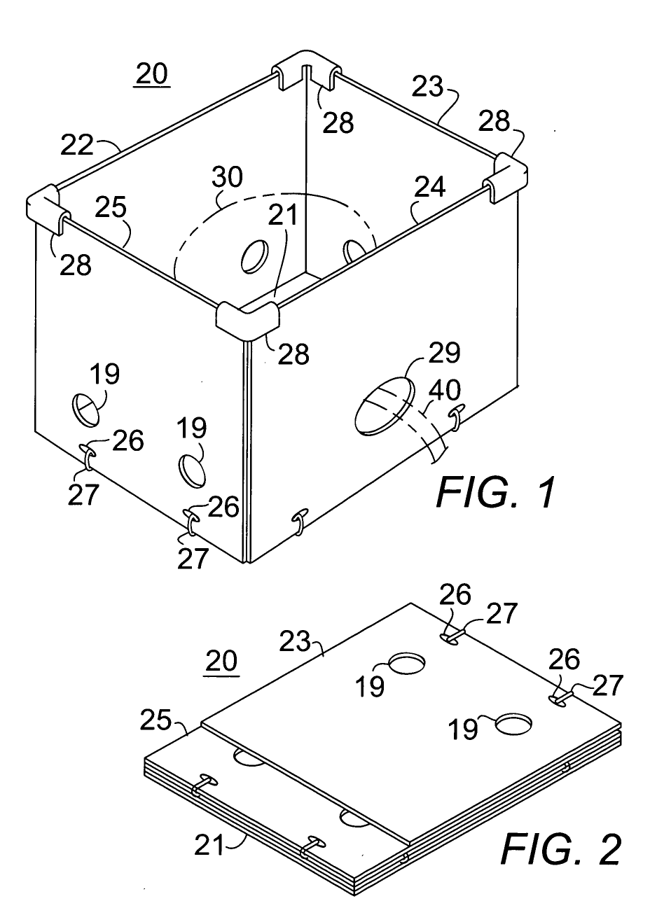

In FIG. 1-3, a windscreen device 20 for an outdoor grill 30 comprises a series of rigid plates 21-25, which include a horizontal bottom plate 21 and four vertical side plates 22-25. The vertical side plates 22-25 contact each other and the bottom plate 21 to form an enclosure for retaining a grill 30 inside to shield the grill from the wind and catch grease spills from the grill. The rigid plates 21-25 are capable of being alternately interconnected to form a wind screen 20, as in FIG. 1, which is capable of housing an outdoor cooking means 30 and screening out the wind from the outdoor cooking means 30 and alternately folded down, on top of the bottom plate 21, with all of the plates 21-25 stacked together for storage, as shown in FIG. 2.

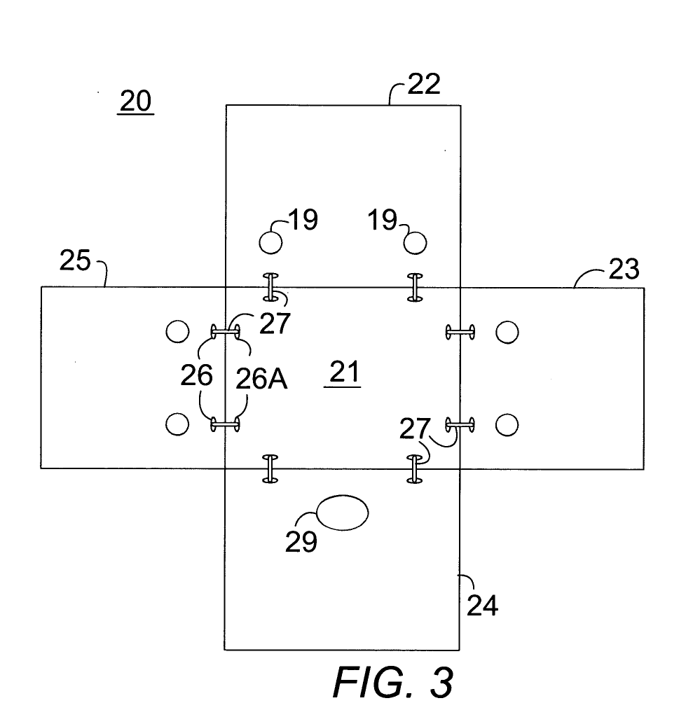

The windscreen device 20 also comprises a series of bottom connecting means for interconnecting each of the side plates 22-25 to the bottom plate 21. The bottom connecting means is capable of forming a flexible pivoting connection so that the side plates 22-25 are capable of alternate upright orthogonal alignment with the bottom plate 21, as in FIG. 1, and further capable of being folded down onto the bottom plate 21 in a stacked array, as shown in FIG. 2 or opened outwardly as shown in FIG. 3. Each of the side plates 22-25 has one pair of slotted openings 26 therethrough, which run parallel and adjacent to a bottom edge of the side plate 22-25. The bottom plate 21 has four pairs of slotted mating openings 26A therethrough. The series of bottom connecting means comprises a series of rings 27, each insertable through adjacent mating openings 26 and 26A between a side plate 22-25 and the bottom plate 21. The rings 27 comprise a split metal ring that is capable of opening to be inserted through the plate openings 26 and 26A and also capable of closing to secure the plates 21-25 together, as shown in FIG. 1. The ring 27 in slot 26 connections are loose enough to permit the folding down of the side plates onto the bottom plate for storage.

The windscreen device 20 also includes a series of top connecting means for interconnecting each side plate 22-25 to each adjacent side plate 22-25 so that each of the top connecting means may be installed on an adjacent pair of side plates (22 and 23 for example) to maintain the side plates 22-25 upright in contacting alignment with each other and with the bottom plate 21. The series of top connecting means can be removed from the side plates 22-25 to allow the side plates 22-25 to fold down upon the bottom plate 21, as shown in FIG. 3. Each of the series of top connecting means comprises an angled clip 28. The bottom plate 21 of the wind screen device 20 is rectangular and there are four side plates 22-25 intersecting at right angles, the angled clip 28 is formed with a right bend angle to match and conform to the angles of the intersecting adjacent side plates (22 and 23 for example). The angled clip 28 has an outer tab and an inner tab on each side of the bend angle. The outer tab and the inner tab spaced apart by a distance slightly less than the thickness of the side plates 22-25 so that the angled clip 28 fits over the top edges of the two adjacent side panels at the contact point of the two adjacent side panels with a tight friction fit. The angled clips 28 of the top connecting means are fabricated of a heat resistant material, and may be molded of a heat resistant synthetic material or formed from cut and bent sheet metal.

The windscreen device 20 further includes an additional opening 29 in one of its side plates 24, which is designed to admit a gas hose 40 therethrough. The side plates may further comprise air vent openings 19.

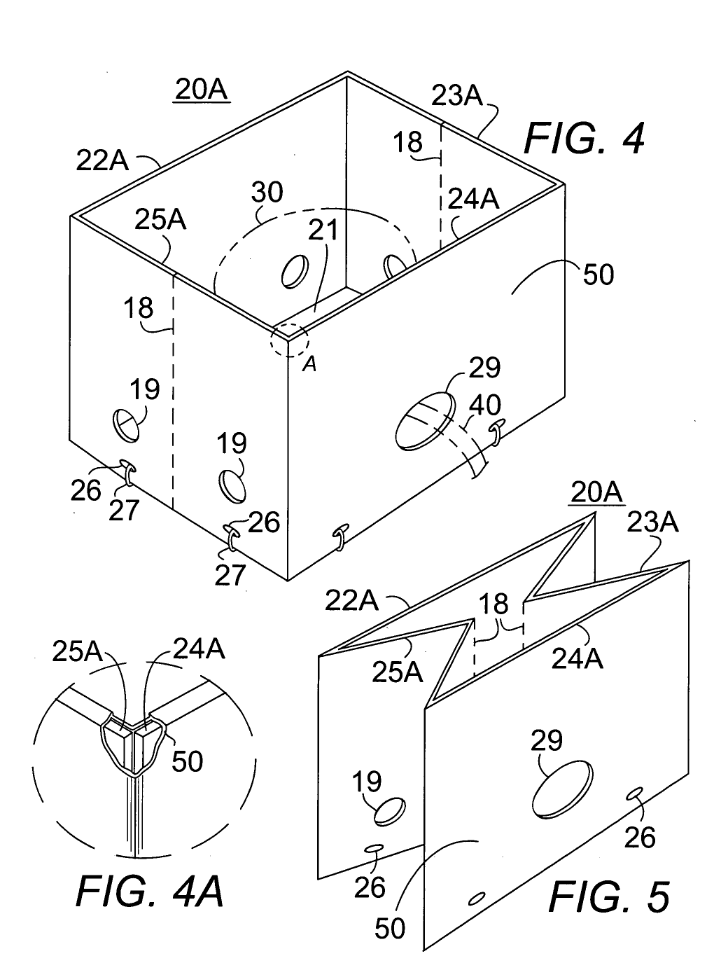

In FIGS. 4, 4A, and 5, an alternate embodiment of the outdoor grill windscreen device 20A has the side plates 22A, 23A, 24A, and 25A all covered by a single piece of material 50 and bendable corners and two opposite bendable sidewalls 23A and 25A having a bendable vertical centerline 18 capable of bending inwardly, as in FIG. 5, to collapse the four side plates for storage. The piece forming the four panels may be fabricated of an inexpensive material such as cardboard plates which may be covered with foil cloth so that the panels are hinged by the foil cloth.

The windscreen device 20 may be manufactured from aluminum; galvanized steel, textured aluminum, tin or foil cloth covered cardboard panels. The thickness of the panels can be between, for example, 20 and 22 gauge thickness in aluminum, and 24-26 gauge in steel. The bottom panel 21 needs to be manufactured from metal. The angled clips 28 of the top connecting means are fabricated of a heat resistant material, and may be molded of a heat resistant synthetic material or formed from cut and bent sheet metal.

To assemble the outdoor grill windscreen 20 a user would align slotted openings 26 of the first side panel 22 with the slotted openings 26A of the bottom panel 21. The user would then open the split ring 27 and thread the ring 27 through the both openings 26 and 26A. This procedure would need to be repeated for the remaining side panels 23-25. The first side panel 22 and the second side panel 23 would be raised to an upright position, perpendicular to the bottom plate 21 and at right angles to each other, and connected together with an angled clip 28. The angled clip 28 fits over the top edges of the two adjacent side panels 22 and 23 at the contact point of the two adjacent side panels 22 and 23 with a tight friction fit. This process would then be repeated with the remaining side panels 23 to 24, 24 to 25, and 25 to 22, to form an enclosure 20, as shown in FIG. 1. Additionally, plastic sleeves (not shown) may be added to cover the upper edges of the side panels 22-25, so that sharp metal edges do not cut the user.

After assembling the device 20 a gas hose 40 from the outdoor cooking unit 30 may be inserted through the additional opening 29, which is located in a side plate 24, for hookup to a gas tank exterior to the device.

To disassemble the outdoor grill windscreen 20 a user would remove the angled clips 28 from the side plates 22-25 to allow the side plates 22-25 to fold down upon the bottom plate 21, as shown in FIG. 3.

It is understood that the preceding description is given merely by way of illustration and not in limitation of the invention and that various modifications may be made thereto without departing from the spirit of the invention as claimed.

1. A wind screen device for an outdoor grill comprising:
a series of rigid plates comprising a horizontal bottom plate and a series of vertical side plates contacting each other and contacting the bottom plate to form an enclosure, the rigid plates capable of being alternately interconnected to form a wind screen capable of housing an outdoor cooking means and further capable of screening out the wind from the outdoor cooking means and alternately folded down with all of the plates stacked together for storage;
a series of bottom connecting means for interconnecting each of the side plates to the bottom plate, the bottom connecting means capable of forming a flexible pivoting connection so that the side plates are capable of alternate orthogonal alignment with the bottom plate and further capable of being folded down onto the bottom plate in a stacked array;
a series of top connecting means for interconnecting each side plate to each adjacent side plate so that each of the top connecting means may be installed on an adjacent pair of side plates to maintain the side plates upright in contacting alignment with each other and with the bottom plate and removed from the side plates to allow the side plates to fold down upon the bottom plate.

2. The wind screen device of claim 1 wherein each of the side plates has at least one pair of openings therethrough adjacent to a bottom edge of the side plate and the bottom plate has at least one pair of mating openings therethrough adjacent to each edge of the bottom plate and the series of bottom connecting means comprises a series of rings each insertable through adjacent mating openings between the bottom plate and a side plate.

3. The wind screen device of claim 2 wherein each of the series of rings comprises a split metal ring capable of opening to be inserted through the plate openings and capable of closing to secured the plates together.

4. The wind screen device of claim 2 wherein each of the openings comprises a slotted opening running parallel to the adjacent edge of each of the plates.

5. The wind screen device of claim 1 wherein each of the series of top connecting means comprises an angled clip having a bend angle therein conforming to the angle between adjacent side plates and an outer tab and an inner tab on each side of the bend angle, the outer tab and the inner tab spaced apart by a distance slightly less than the thickness of the side plates so that the angled clip fits over the top edges of the two adjacent side panels at the contact point of the two adjacent side panels with a tight friction fit.

6. The wind screen device of claim 5 wherein each of the series of top connecting means is fabricated of a heat resistant material.

7. The wind screen device of claim 6 wherein each of the series of top connecting means is molded of a heat resistant synthetic material.

8. The wind screen device of claim 6 wherein each of the series of top connecting means is formed of cut and bent sheet metal.

9. The wind screen device of claim 5 wherein the bottom plate is rectangular and there are four side plates intersecting at right angles and the angled clip is formed with a right bend angle.

10. The wind screen device of claim 1 wherein one of the side plates has an additional opening therethrough to admit a gas hose therethrough.

11. The wind screen device of claim 1 wherein at least one of the side plates further comprises an air vent hole therethrough.

12. The wind screen device of claim 1 wherein the side plates are covered by a resilient fire resistant flexible material forming bendable corners between the side plates and two opposing plates of the side plates are bendable along a vertical centerline of each of the opposing plates to enable the side plates to be collapsed flat together for storage.
